(19) United States
(12) Patent Application Publication
(10) Pub. No.: US 2020/0159233 A1
(43) Pub. Date: May 21, 2020

(54) Memory-Based Optimal Motion Planning With Dynamic Model For Automated Vehicle

(71) Applicant: Great Wall Motor Company Limited, Baoding (CN)

(72) Inventors: Kai Zhang, Carmel, IN (US); Duong Le, Westland, MI (US); Zhichao Liu, Novi, MI (US)

(73) Assignee: Great Wall Motor Company Limited, Baoding (CN)

(21) Appl. No.: 16/230,094

(22) Filed: Dec. 21, 2018

Related U.S. Application Data
(60) Provisional application No. 62/768,425, filed on Nov. 16, 2018.

(51) Int. Cl. G05D 1/02; G05D 1/00

(52) U.S. Cl. CPC G05D 1/0221; G05D 1/0223; G05D 2201/0213; G05D 1/0088; G05D 1/0274

(57) ABSTRACT

Methods and apparatus are described for motion planning of a vehicle. A motion planner uses previous motion graph data included in a motion graph tree and a look-up table (LUT) to generate candidate trajectory(ies). The motion graph tree is updated with motion graph data associated with the candidate trajectory(ies) upon a terminate condition. A trajectory from the candidate trajectory(ies) is selected and a controller is updated with the trajectory to control the vehicle. A path planner uses previous configuration graph data in a configuration graph tree to generate candidate path(s). The configuration graph tree is updated with configuration graph data associated with the candidate path(s) upon a terminate conditions. A path is selected from the candidate path(s). A velocity planner algorithm determines a velocity from the path. A LUT is used to assist in the velocity determination. A controller is updated with the path and velocity to control the vehicle.

### CROSS-REFERENCE TO RELATED APPLICATIONS

This application claims priority to and the benefit of U.S. Provisional Application Patent Ser. No. 62/768,425, filed Nov. 16, 2018, the entire disclosure of which is hereby incorporated by reference.

This application is related to application entitled “MOTION PLANNING METHODS AND SYSTEMS FOR AUTONOMOUS VEHICLE” having an Attorney Docket No. HAVAL-103-B, filed on same date, the entire disclosure of which is hereby incorporated by reference.

### TECHNICAL FIELD

This disclosure relates to autonomous vehicles. More specifically, this disclosure relates to controllers, controller systems, and controller methods for autonomous vehicles.

### SUMMARY

Disclosed herein are implementations of memory-based motion planning. The memory-based motion planning may include one or more dynamic models.

Methods and apparatus are described for motion planning of a vehicle. The method includes initializing a motion graph tree. A motion planner uses previous motion graph data included in the motion graph tree and a look-up table (LUT) to generate candidate trajectory(ies). The motion graph tree is updated with motion graph data associated with the candidate trajectory(ies) when a terminate condition has occurred. A trajectory from the candidate trajectory(ies) is selected and a controller is updated with the trajectory to control the vehicle. A method may include initializing a configuration graph tree. A path planner uses previous configuration graph data in the configuration graph tree to generate candidate path(s). The configuration graph tree is updated with configuration graph data associated with the candidate path(s) when a terminate condition has occurred. A path is selected from the candidate path(s). A velocity planner algorithm is applied to the path and uses a LUT to determine a velocity. A controller is updated with the path and the velocity to control the vehicle.

A method may be used for motion planning of a vehicle. The vehicle may be an autonomous vehicle (AV) and may be referred to as a host vehicle. A method for motion planning in an autonomous vehicle (AV) may include initializing a graph. The method may include determining whether a terminate condition has occurred. The method may include, on a condition that the terminate condition has occurred, saving the graph data and searching the graph. On a condition that the terminate condition has not occurred, the method may include for each open vertex in the graph, and for each control in a control set, applying a respective control to a respective open node to obtain a new state. The method may include determining whether a motion from the open vertex to the new state is valid. On a condition that the motion is valid, the method may include adding the new vertex and edge to the graph. The method may include sampling a target. The method may include selecting a vertex in the graph. The method may include computing a control input for a motion from a motion/configuration state to a motion/configuration state target. The method may include obtaining a new state. On a condition that the new state is valid, the method may include adding the new state as new vertex and new edge to the graph.

An AV controller may include a motion planning component. The motion planning component may be configured to initialize a graph, determine whether a terminate condition has occurred, and on a condition that the terminate condition has occurred, save the graph data and search the graph. The motion planning component may be further configured to, on a condition that the terminate condition has not occurred, for each open vertex in the tree, and for each control in a control set, apply a respective control to a respective open node to obtain a new state. The motion planning component may be further configured to determine whether a motion from the open vertex to the new state is valid. On a condition that the motion is valid, the motion planning component may be configured to add the new vertex to the tree. The motion planning component may be further configured to add the saved graph data to a current graph data. The motion planning component may be further configured to sample a target, select a vertex in the graph, compute a control input for a motion from the vertex's motion state to the target, obtain a new state, and on a condition that the new state is valid, add the new state as new vertex and new edge to the graph.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of a vehicle in accordance with embodiments of this disclosure.

FIG. 2 is a diagram of an example of the control system shown in FIG. 1.

FIG. 3 is a diagram of an example of a vehicle control system in accordance with embodiments of this disclosure.

FIG. 4 is a diagram of an example of a side view of a vehicle including a vehicle control system in accordance with embodiments of this disclosure.

FIG. 5 is a diagram of an example of a vehicle control system in accordance with embodiments of this disclosure.

FIG. 6 is a diagram of an example of an autonomous vehicle motion planning method in accordance with embodiments of this disclosure.

FIG. 7 is a diagram of an example of a numerical optimization method in accordance with embodiments of this disclosure.

FIG. 8 is a diagram of an example of a model predictive control-based method in accordance with embodiments of this disclosure.

FIG. 9 is a diagram of an example of a lattice planner in a sampling-based method in accordance with embodiments of this disclosure.

FIGS. 10A-10M are diagrams of an example lattice planner graphical sequence in accordance with embodiments of this disclosure.

FIG. 11 is a diagram of an example of a rapidly-exploring random tree (RRT) in a sampling-based method in accordance with embodiments of this disclosure.

FIGS. 12A-12O are diagrams of an example sampling-based planner graphical sequence in accordance with embodiments of this disclosure.

FIG. 13 is a diagram of an example of a path velocity decomposition method in accordance with embodiments of this disclosure.

FIG. 14 is a diagram of an example of an RRT path planner in a path velocity decomposition method in accordance with embodiments of this disclosure.

FIG. 15 is a diagram of an example of a lattice planner in a path velocity decomposition method in accordance with embodiments of this disclosure.

FIG. 16 is a diagram of an example of velocity planning in a path velocity decomposition method in accordance with embodiments of this disclosure.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices and methods shown and described herein.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Autonomous vehicles (AV)s are a maturing technology with the potential to reshape mobility by enhancing the safety, accessibility, efficiency, and convenience of automotive transportation. Safety-critical tasks that may be executed by an AV include planning of motions through a dynamic environment shared with other vehicles and pedestrians, and their robust executions via feedback control. The AV may include a processor that includes a motion processing layer. The motion planning layer may be configured to compute a safe, comfortable, and dynamically feasible trajectory from a current configuration of the vehicle to a goal configuration provided by the behavioral layer of the decision-making hierarchy. Depending on context, the goal configuration may differ. For example, the goal location may be the center point of the current lane a few meters ahead in the direction of travel, the center of the stop line at the next intersection, or the next desired parking spot. A controller may include a motion planning component that receives information about static and dynamic obstacles around the vehicle and generates a collision-free trajectory that satisfies dynamic and kinematic constraints on the motion of the vehicle. The motion planning component may compute a trajectory that is safe and comfortable for the controller to execute. The computed trajectory may be based on localization, vehicle status (position, velocity, acceleration, chassis), map, routing, perception, prediction, or any combination thereof. An aspect of AV motion planning is the limitation of processing time. Motion planning must run in real-time to have a fast response to the change of environment to ensure safety.

To increase the speed of motion planning, the embodiments disclosed herein may apply previous planning data, a look up table for dynamic calculation, or both. For AV motion planning, the change of environment in each planning cycle is relatively small. Instead of discarding all previous planning cycle calculations, a new planning cycle may be configured to utilize that information to decrease processing time. The methods to utilize previous planning data may depend on the type of planner. Another computational cost time is calculating the dynamic motion of the vehicle. By precomputing dynamic motion offline, and using a look up table (LUT) when needed, the process time may decrease, however, it may sacrifice the precision of calculation, which trades off between the efficiency and computation.

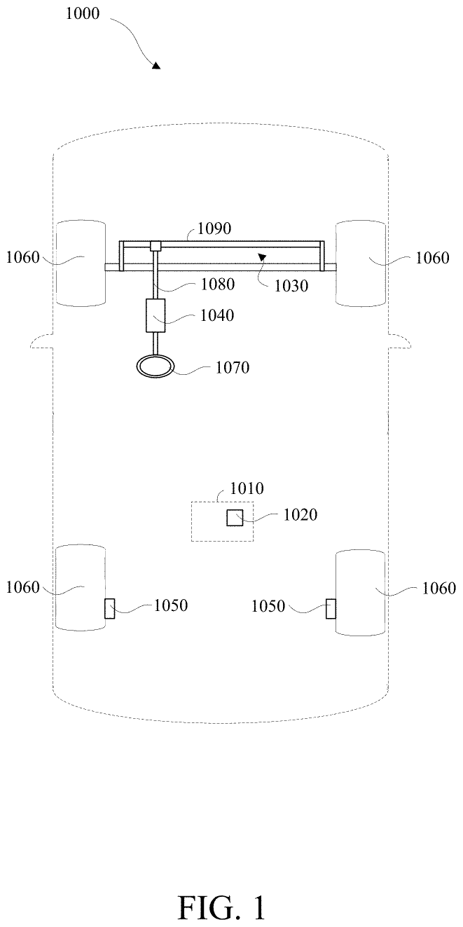

FIG. 1 is a diagram of an example of a vehicle 1000 in accordance with embodiments of this disclosure. The vehicle 1000 may be an autonomous vehicle (AV) or a semi-autonomous vehicle. As shown in FIG. 1, the vehicle 1000 includes a control system 1010. The control system 1010 may be referred to as a controller. The control system 1010 includes a processor 1020. The processor 1020 is programmed to command application of one of up to a predetermined steering torque value and up to a predetermined net asymmetric braking force value. Each predetermined force is selected to achieve a predetermined vehicle yaw torque that is at most the lesser of a first maximum yaw torque resulting from actuating a steering system 1030 and a second maximum yaw torque resulting from actuating a brake system.

The steering system 1030 may include a steering actuator 1040 that is an electric power-assisted steering actuator. The brake system may include one or more brakes 1050 coupled to respective wheels 1060 of the vehicle 1000. Additionally, the processor 1020 may be programmed to command the brake system to apply a net asymmetric braking force by each brakes 1050 applying a different braking force than the other brakes 1050.

The processor 1020 may be further programmed to command the brake system to apply a braking force, for example a net asymmetric braking force, in response to a failure of the steering system 1030. Additionally or alternatively, the processor 1020 may be programmed to provide a warning to an occupant in response to the failure of the steering system 1030. The steering system 1030 may be a power-steering control module. The control system 1010 may include the steering system 1030. Additionally, the control system 1010 may include the brake system.

The steering system 1030 may include a steering actuator 1040 that is an electric power-assisted steering actuator. The brake system may include two brakes 1050 coupled to respective wheels 1060 on opposite sides of the vehicle 1000. Additionally, the method may include commanding the brake system to apply a net asymmetric braking force by each brakes 1050 applying a different braking force.

The control system 1010 allows one of the steering system 1030 and the brake system to take over for the other of the steering system 1030 and the brake system if the other fails while the vehicle 1000 is executing a turn. Whichever of the steering system 1030 and the braking system remains operable is then able to apply sufficient yaw torque to the vehicle 1000 to continue the turn. The vehicle 1000 is therefore less likely to impact an object such as another vehicle or a roadway barrier, and any occupants of the vehicle 1000 are less likely to be injured.

The vehicle 1000 may operate in one or more of the levels of autonomous vehicle operation. For purposes of this disclosure, an autonomous mode is defined as one in which each of propulsion (e.g., via a powertrain including an electric motor and/or an internal combustion engine), braking, and steering of the vehicle 1000 are controlled by the processor 1020; in a semi-autonomous mode the processor 1020 controls one or two of the propulsion, braking, and steering of the vehicle 1000. Thus, in one example, non-autonomous modes of operation may refer to SAE levels 0-1, partially autonomous or semi-autonomous modes of operation may refer to SAE levels 2-3, and fully autonomous modes of operation may refer to SAE levels 4-5.

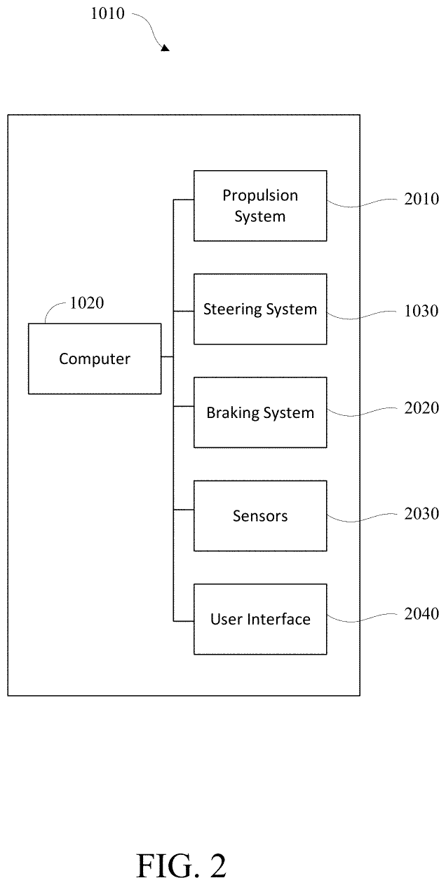

With reference to FIG. 2, the control system 1010 includes the processor 1020. The processor 1020 is included in the vehicle 1000 for carrying out various operations, including as described herein. The processor 1020 is a computing device that generally includes a processor and a memory, the memory including one or more forms of computer-readable media, and storing instructions executable by the processor for performing various operations, including as disclosed herein. The memory of the processor 1020 further generally stores remote data received via various communications mechanisms; e.g., the processor 1020 is generally configured for communications on a communications network within the vehicle 1000. The processor 1020 may also have a connection to an onboard diagnostics connector (OBD-II). Although one processor 1020 is shown in FIG. 2 for ease of illustration, it is to be understood that the processor 1020 could include, and various operations described herein could be carried out by, one or more computing devices. The processor 1020 may be a control module, for example, a power-steering control module, or may include a control module among other computing devices.

The control system 1010 may transmit signals through the communications network, which may be a controller area network (CAN) bus, Ethernet, Local Interconnect Network (LIN), Bluetooth, and/or by any other wired or wireless communications network. The processor 1020 may be in communication with a propulsion system 2010, the steering system 1030, the brake system 2020, sensors 2030, and/or a user interface 2040, among other components.

With continued reference to FIG. 2, the propulsion system 2010 of the vehicle 1000 generates energy and translates the energy into motion of the vehicle 1000. The propulsion system 2010 may be a known vehicle propulsion subsystem, for example, a conventional powertrain including an internal-combustion engine coupled to a transmission that transfers rotational motion to road wheels 1060; an electric powertrain including batteries, an electric motor, and a transmission that transfers rotational motion to the road wheels 1060; a hybrid powertrain including elements of the conventional powertrain and the electric powertrain; or any other type of propulsion. The propulsion system 2010 is in communication with and receives input from the processor 1020 and from a human driver. The human driver may control the propulsion system 2010 via, e.g., an accelerator pedal and/or a gear-shift lever (not shown).

With reference to FIGS. 1 and 2, the steering system 1030 is typically a known vehicle steering subsystem and controls the turning of the road wheels 1060. The steering system 1030 is in communication with and receives input from a steering wheel 1070 and the processor 1020. The steering system 1030 may be a rack-and-pinion system with electric power-assisted steering via a steering actuator 1040, a steer-by-wire system, as are both known in the art, or any other suitable system. The steering system 1030 may include the steering wheel 1070 fixed to a steering column 1080 coupled to a steering rack 1090.

With reference to FIG. 1, the steering rack 1090 is turnably coupled to the road wheels 1060, for example, in a four-bar linkage. Translational motion of the steering rack 1090 results in turning of the road wheels 1060. The steering column 1080 may be coupled to the steering rack 1090 via a rack-and-pinion, that is, gear meshing between a pinion gear and a rack gear (not shown).

The steering column 1080 transfers rotation of the steering wheel 1070 to movement of the steering rack 1090. The steering column 1080 may be, e.g., a shaft connecting the steering wheel 1070 to the steering rack 1090. The steering column 1080 may house a torsion sensor and a clutch (not shown).

The steering wheel 1070 allows an operator to steer the vehicle 1000 by transmitting rotation of the steering wheel 1070 to movement of the steering rack 1090. The steering wheel 1070 may be, e.g., a rigid ring fixedly attached to the steering column 1080 such as is known.

With continued reference to FIG. 1, the steering actuator 1040 is coupled to the steering system 1030, e.g., the steering column 1080, so as to cause turning of the road wheels 1060. For example, the steering actuator 1040 may be an electric motor rotatably coupled to the steering column 1080, that is, coupled so as to be able to apply a steering torque to the steering column 1080. The steering actuator 1040 may be in communication with the processor 1020.

The steering actuator 1040 may provide power assist to the steering system 1030. In other words, the steering actuator 1040 may provide torque in a direction in which the steering wheel 1070 is being rotated by a human driver, allowing the driver to turn the steering wheel 1070 with less effort. The steering actuator 1040 may be an electric power-assisted steering actuator.

With reference to FIGS. 1 and 2, the brake system 2020 is typically a known vehicle braking subsystem and resists the motion of the vehicle 1000 to thereby slow and/or stop the vehicle 1000. The brake system 2020 includes brakes 1050 coupled to the road wheels 1060. The brakes 1050 may be friction brakes such as disc brakes, drum brakes, band brakes, and so on; regenerative brakes; any other suitable type of brakes; or a combination. The brakes 1050 may be coupled to, e.g., respective road wheels 1060 on opposite sides of the vehicle 1000. The brake system 2020 is in communication with and receives input from the processor 1020 and a human driver. The human driver may control the braking via, e.g., a brake pedal (not shown).

With reference to FIG. 2, the vehicle 1000 may include the sensors 2030. The sensors 2030 may detect internal states of the vehicle 1000, for example, wheel speed, wheel orientation, and engine and transmission variables. The sensors 2030 may detect the position or orientation of the vehicle 1000, for example, global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 2030 may detect the external world, for example, radar sensors, scanning laser range finders, light detection and ranging (LIDAR) devices, and image processing sensors such as cameras. The sensors 2030 may include communications devices, for example, vehicle-to-infrastructure (V2I) devices, vehicle-to-vehicle (V2V) devices, or vehicle-to-everything (V2V) devices.

The user interface 2040 presents information to and receives information from an occupant of the vehicle 1000. The user interface 2040 may be located, e.g., on an instrument panel in a passenger cabin (not shown) of the vehicle 1000, or wherever may be readily seen by the occupant. The user interface 2040 may include dials, digital readouts, screens, speakers, and so on for output, i.e., providing information to the occupant, e.g., a human-machine interface (HMI) including elements such as are known. The user interface 2040 may include buttons, knobs, keypads, touchscreens, microphones, and so on for receiving input, i.e., information, instructions, etc., from the occupant.

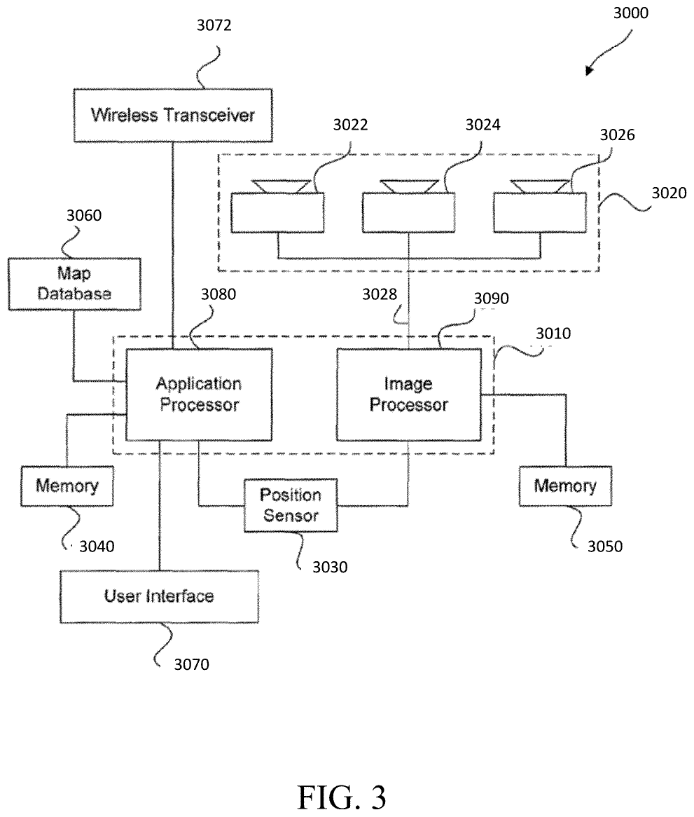

FIG. 3 is a diagram of an example of a vehicle control system 3000 in accordance with embodiments of this disclosure. Vehicle control system 3000 may include various components depending on the requirements of a particular implementation. In some embodiments, vehicle control system 3000 may include a processing unit 3010, an image acquisition unit 3020, a position sensor 3030, one or more memory units 3040, 3050, a map database 3060, a user interface 3070, and a wireless transceiver 3072. Processing unit 3010 may include one or more processing devices. In some embodiments, processing unit 3010 may include an applications processor 3080, an image processor 3090, or any other suitable processing device. Similarly, image acquisition unit 3020 may include any number of image acquisition devices and components depending on the requirements of a particular application. In some embodiments, image acquisition unit 3020 may include one or more image capture devices (e.g., cameras, CCDs, or any other type of image sensor), such as image capture device 3022, image capture device 3024, and image capture device 3026. System 3000 may also include a data interface 3028 communicatively connecting processing unit 3010 to image acquisition unit 3020. For example, data interface 3028 may include any wired and/or wireless link or links for transmitting image data acquired by image acquisition unit 3020 to processing unit 3010.

Wireless transceiver 3072 may include one or more devices configured to exchange transmissions over an air interface to one or more networks (e.g., cellular, the Internet, etc.) by use of a radio frequency, infrared frequency, magnetic field, or an electric field. Wireless transceiver 3072 may use any known standard to transmit and/or receive data (e.g., Wi-Fi, Bluetooth®, Bluetooth Smart, 802.15.4, ZigBee, etc.). Such transmissions may include communications from the host vehicle to one or more remotely located servers. Such transmissions may also include communications (one-way or two-way) between the host vehicle and one or more target vehicles in an environment of the host vehicle (e.g., to facilitate coordination of navigation of the host vehicle in view of or together with target vehicles in the environment of the host vehicle), or even a broadcast transmission to unspecified recipients in a vicinity of the transmitting vehicle.

Both applications processor 3080 and image processor 3090 may include various types of hardware-based processing devices. For example, either or both of applications processor 3080 and image processor 3090 may include a microprocessor, preprocessors (such as an image preprocessor), graphics processors, a central processing unit (CPU), support circuits, digital signal processors, integrated circuits, memory, or any other types of devices suitable for running applications and for image processing and analysis. In some embodiments, applications processor 180 and/or image processor 190 may include any type of single or multi-core processor, mobile device microcontroller, central processing unit, or the like.

In some embodiments, applications processor 3080 and/or image processor 3090 may include multiple processing units with local memory and instruction sets. Such processors may include video inputs for receiving image data from multiple image sensors and may also include video out capabilities. In one example, the processor may use 90 nm-micron technology operating at 332 Mhz.

Any of the processing devices disclosed herein may be configured to perform certain functions. Configuring a processing device, such as any of the described processors, other controllers or microprocessors, to perform certain functions may include programming of computer executable instructions and making those instructions available to the processing device for execution during operation of the processing device. In some embodiments, configuring a processing device may include programming the processing device directly with architectural instructions. In other embodiments, configuring a processing device may include storing executable instructions on a memory that is accessible to the processing device during operation. For example, the processing device may access the memory to obtain and execute the stored instructions during operation. In either case, the processing device configured to perform the sensing, image analysis, and/or navigational functions disclosed herein represents a specialized hardware-based system in control of multiple hardware based components of a host vehicle.

While FIG. 3 depicts two separate processing devices included in processing unit 3010, more or fewer processing devices may be used. For example, in some embodiments, a single processing device may be used to accomplish the tasks of applications processor 3080 and image processor 3090. In other embodiments, these tasks may be performed by more than two processing devices. Further, in some embodiments, vehicle control system 3000 may include one or more of processing unit 3010 without including other components, such as image acquisition unit 3020.

Processing unit 3010 may comprise various types of devices. For example, processing unit 3010 may include various devices, such as a controller, an image preprocessor, a central processing unit (CPU), support circuits, digital signal processors, integrated circuits, memory, or any other types of devices for image processing and analysis. The image preprocessor may include a video processor for capturing, digitizing and processing the imagery from the image sensors. The CPU may comprise any number of microcontrollers or microprocessors. The support circuits may be any number of circuits generally well known in the art, including cache, power supply, clock and input-output circuits. The memory may store software that, when executed by the processor, controls the operation of the system. The memory may include databases and image processing software. The memory may comprise any number of random access memories, read only memories, flash memories, disk drives, optical storage, tape storage, removable storage and other types of storage. In one instance, the memory may be separate from the processing unit 3010. In another instance, the memory may be integrated into the processing unit 3010.

Each memory 3040, 3050 may include software instructions that when executed by a processor (e.g., applications processor 3080 and/or image processor 3090), may control operation of various aspects of vehicle control system 3000. These memory units may include various databases and image processing software, as well as a trained system, such as a neural network, or a deep neural network, for example. The memory units may include random access memory, read only memory, flash memory, disk drives, optical storage, tape storage, removable storage and/or any other types of storage. In some embodiments, memory units 3040, 3050 may be separate from the applications processor 3080 and/or image processor 3090. In other embodiments, these memory units may be integrated into applications processor 3080 and/or image processor 3090.

Position sensor 3030 may include any type of device suitable for determining a location associated with at least one component of vehicle control system 3000. In some embodiments, position sensor 3030 may include a GPS receiver. Such receivers can determine a user position and velocity by processing signals broadcasted by global positioning system satellites. Position information from position sensor 3030 may be made available to applications processor 3080 and/or image processor 3090.

In some embodiments, vehicle control system 3000 may include components such as a speed sensor (e.g., a speedometer) for measuring a speed of vehicle 1000. Vehicle control system 3000 may also include one or more accelerometers (either single axis or multi-axis) for measuring accelerations of vehicle 1000 along one or more axes.

The memory units 3040, 3050 may include a database, or data organized in any other form, that indication a location of known landmarks. Sensory information (such as images, radar signal, depth information from lidar or stereo processing of two or more images) of the environment may be processed together with position information, such as a GPS coordinate, vehicle's ego motion, etc. to determine a current location of the vehicle relative to the known landmarks, and refine the vehicle location.

User interface 3070 may include any device suitable for providing information to or for receiving inputs from one or more users of vehicle control system 3000. In some embodiments, user interface 3070 may include user input devices, including, for example, a touchscreen, microphone, keyboard, pointer devices, track wheels, cameras, knobs, buttons, or the like. With such input devices, a user may be able to provide information inputs or commands to vehicle control system 3000 by typing instructions or information, providing voice commands, selecting menu options on a screen using buttons, pointers, or eye-tracking capabilities, or through any other suitable techniques for communicating information to vehicle control system 3000.

User interface 3070 may be equipped with one or more processing devices configured to provide and receive information to or from a user and process that information for use by, for example, applications processor 3080. In some embodiments, such processing devices may execute instructions for recognizing and tracking eye movements, receiving and interpreting voice commands, recognizing and interpreting touches and/or gestures made on a touchscreen, responding to keyboard entries or menu selections, etc. In some embodiments, user interface 3070 may include a display, speaker, tactile device, and/or any other devices for providing output information to a user.

Map database 3060 may include any type of database for storing map data useful to vehicle control system 3000. In some embodiments, map database 3060 may include data relating to the position, in a reference coordinate system, of various items, including roads, water features, geographic features, businesses, points of interest, restaurants, gas stations, etc. Map database 3060 may store not only the locations of such items, but also descriptors relating to those items, including, for example, names associated with any of the stored features. In some embodiments, map database 3060 may be physically located with other components of vehicle control system 3000. Alternatively or additionally, map database 3060 or a portion thereof may be located remotely with respect to other components of vehicle control system 3000 (e.g., processing unit 3010). In such embodiments, information from map database 3060 may be downloaded over a wired or wireless data connection to a network (e.g., over a cellular network and/or the Internet, etc.). In some cases, map database 3060 may store a sparse data model including polynomial representations of certain road features (e.g., lane markings) or target trajectories for the host vehicle. Map database 3060 may also include stored representations of various recognized landmarks that may be used to determine or update a known position of the host vehicle with respect to a target trajectory. The landmark representations may include data fields such as landmark type, landmark location, among other potential identifiers.

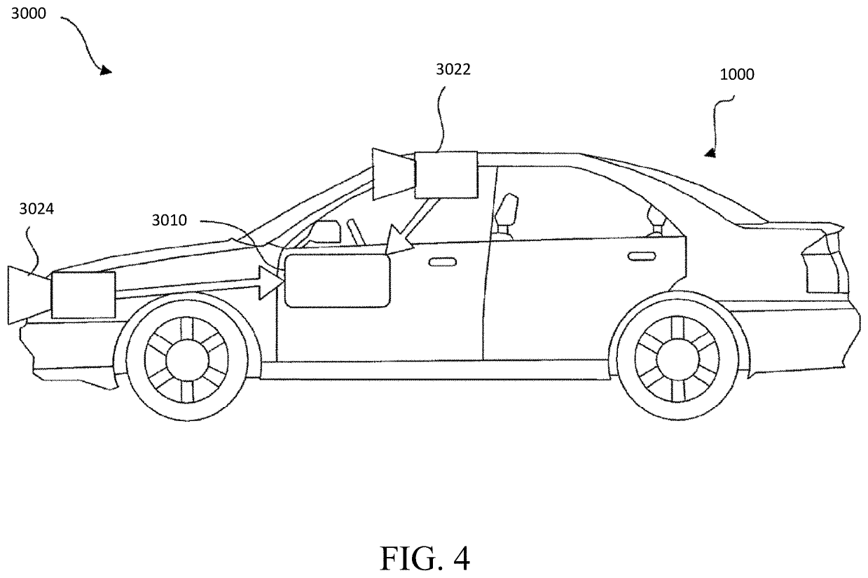

Image capture devices 3022, 3024, and 3026 may each include any type of device suitable for capturing at least one image from an environment. Moreover, any number of image capture devices may be used to acquire images for input to the image processor. Some embodiments may include only a single image capture device, while other embodiments may include two, three, or even four or more image capture devices. Image capture devices 3022, 3024, and 3026 will be further described with reference to FIG. 4 below.

One or more cameras (e.g., image capture devices 3022, 3024, and 3026) may be part of a sensing block included on a vehicle. Various other sensors may be included in the sensing block, and any or all of the sensors may be relied upon to develop a sensed navigational state of the vehicle. In addition to cameras (forward, sideward, rearward, etc.), other sensors such as RADAR, LIDAR, and acoustic sensors may be included in the sensing block. Additionally, the sensing block may include one or more components configured to communicate and transmit/receive information relating to the environment of the vehicle. For example, such components may include wireless transceivers (RF, etc.) that may receive from a source remotely located with respect to the host vehicle sensor based information or any other type of information relating to the environment of the host vehicle. Such information may include sensor output information, or related information, received from vehicle systems other than the host vehicle. In some embodiments, such information may include information received from a remote computing device, a centralized server, etc. Furthermore, the cameras may take on many different configurations: single camera units, multiple cameras, camera clusters, long FOV, short FOV, wide angle, fisheye, or the like.

FIG. 4 is a diagram of an example of a side view of vehicle 1000 including a vehicle control system 3000 in accordance with embodiments of this disclosure. For example, vehicle 1000 may be equipped with a processing unit 3010 and any of the other components of vehicle control system 3000, as described above relative to FIG. 3. While in some embodiments vehicle 1000 may be equipped with only a single image capture device (e.g., camera), in other embodiments, multiple image capture devices may be used. For example, either of image capture devices 3022 and 3024 of vehicle 1000, as shown in FIG. 4, may be part of an Advanced Driver Assistance Systems (ADAS) imaging set.

The image capture devices included on vehicle 1000 as part of the image acquisition unit 3020 may be positioned at any suitable location. In some embodiments, image capture device 3022 may be located in the vicinity of the rearview mirror. This position may provide a line of sight similar to that of the driver of vehicle 1000, which may aid in determining what is and is not visible to the driver. Image capture device 3022 may be positioned at any location near the rearview mirror, but placing image capture device 3022 on the driver side of the mirror may further aid in obtaining images representative of the driver's field of view and/or line of sight.

Other locations for the image capture devices of image acquisition unit 3020 may also be used. For example, image capture device 3024 may be located on or in a bumper of vehicle 1000. Such a location may be especially suitable for image capture devices having a wide field of view. The line of sight of bumper-located image capture devices can be different from that of the driver and, therefore, the bumper image capture device and driver may not always see the same objects. The image capture devices (e.g., image capture devices 3022, 3024, and 3026) may also be located in other locations. For example, the image capture devices may be located on or in one or both of the side mirrors of vehicle 1000, on the roof of vehicle 1000, on the hood of vehicle 1000, on the trunk of vehicle 1000, on the sides of vehicle 1000, mounted on, positioned behind, or positioned in front of any of the windows of vehicle 1000, and mounted in or near light fixtures on the front and/or back of vehicle 1000.

In addition to image capture devices, vehicle 1000 may include various other components of vehicle control system 3000. For example, processing unit 3010 may be included on vehicle 1000 either integrated with or separate from an engine control unit (ECU) of the vehicle. Vehicle 1000 may also be equipped with a position sensor 3030, such as a GPS receiver and may also include a map database 3060 and memory units 3040 and 3050.

As discussed earlier, wireless transceiver 3072 may and/or receive data over one or more networks (e.g., cellular networks, the Internet, etc.). For example, wireless transceiver 3072 may upload data collected by vehicle control system 3000 to one or more servers, and download data from the one or more servers. Via wireless transceiver 3072, vehicle control system 3000 may receive, for example, periodic or on demand updates to data stored in map database 3060, memory 3040, and/or memory 3050. Similarly, wireless transceiver 3072 may upload any data (e.g., images captured by image acquisition unit 3020, data received by position sensor 3030 or other sensors, vehicle control systems, etc.) from vehicle control system 3000 and/or any data processed by processing unit 3010 to the one or more servers.

Vehicle control system 3000 may upload data to a server (e.g., to the cloud) based on a privacy level setting. For example, vehicle control system 3000 may implement privacy level settings to regulate or limit the types of data (including metadata) sent to the server that may uniquely identify a vehicle and or driver/owner of a vehicle. Such settings may be set by user via, for example, wireless transceiver 3072, be initialized by factory default settings, or by data received by wireless transceiver 3072.

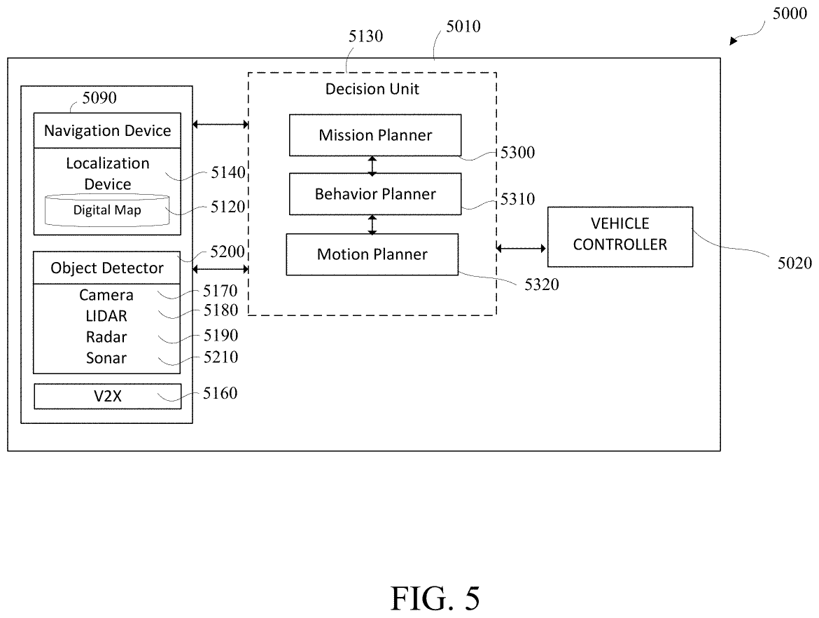

FIG. 5 is a diagram of an example of a vehicle system architecture 5000 in accordance with embodiments of this disclosure. The vehicle system architecture 5000 may be implemented as part of a host vehicle 5010.

Referring to FIG. 5, the vehicle system architecture 5000 includes a navigation device 5090, a decision unit 5130, object detector 5200, V2X communications 5160 and a vehicle controller 5020. The navigation device 5090 may be used by the decision unit 5130 to determine a travel path of the host vehicle 5010 to a destination. The travel path, for example, may include a travel route or a navigation path. The navigation device 5090, the decision unit 5130 and the vehicle controller 5020 may be collectively used to determine where to steer the host vehicle 5010 along a roadway such that the host vehicle 5010 is appropriately located on the roadway relative to, for example, lane markings, curbs, traffic signs, pedestrians, other vehicles, etc., determine a route based on a digital map 5120 that the host vehicle 5010 is instructed to follow to arrive at a destination, or both.

In order to determine where the host vehicle 5010 is located on the digital map 5120, the navigation device 5090 may include a localization device 5140, such as a GPS/GNSS receiver and an inertial measurement unit (IMU). A camera 5170, a radar unit 5190, a sonar unit 5210, a LIDAR unit 5180 or any combination thereof may be used to detect relatively permanent objects proximate to the host vehicle 5010 that are indicated on the digital map 5120, for example, traffic signals, buildings, etc., and determine a relative location relative to those objects in order to determine where the host vehicle 5010 is located on the digital map 5120. This process may be referred to as map localization. The functions of the navigation device 5090, the information provided by the navigation device 5090, or both, may be all or in part by way of V2I communications, V2V communications, vehicle-to-pedestrian (V2P) communications, or a combination thereof, which may generically be labeled as V2X communications 5160.

In some implementations, an object detector 5200 may include the sonar unit 5210, the camera 5170, the LIDAR unit 5180, and the radar unit 5190. The object detector 5200 may be used to detect the relative location of another entity, and determine an intersection point where another entity will intersect the travel path of the host vehicle 5010. In order to determine the intersection point and the relative timing of when the host vehicle 5010 and another entity will arrive at the intersection point, the object detector 5200 may be used by the vehicle system architecture 5000 to determine, for example, a relative speed, a separation distance of another entity from the host vehicle 5010, or both. The functions of the object detector 5200, the information provided by the object detector 5200, or both, may be all or in part by way of V2I communications, V2V communications, V2P communications, or a combination thereof, which may generically be labeled as V2X communications 5160. Accordingly, the vehicle system architecture 5000 may include a transceiver to enable such communications.

The vehicle system architecture 5000 includes a decision unit 5130 that is in communication with the object detector 5200, and the navigation device 5090. The communication may be by way of, but not limited to, wires, wireless communication, or optical fiber. The decision unit 5130 may include a processor(s) such as a microprocessor or other control circuitry such as analog circuitry, digital circuitry, or both, including an application specific integrated circuit (ASIC) for processing data. The decision unit 5130 may include a memory, including non-volatile memory, such as electrically erasable programmable read-only memory (EEPROM) for storing one or more routines, thresholds, captured data, or a combination thereof. The decision unit 5130 may include at least a mission planner 5300, behavior planner 5310 and motion planner 5320, which collectively determine or control route or path planning, local driving behavior and trajectory planning for the host vehicle 5010.

The vehicle system architecture 5000 includes a vehicle controller or trajectory tracker 5020 that is in communication with the decision unit 5130. The vehicle controller 5020 may execute a defined geometric path (which may be provided by the motion planner 5320 or the decision unit 5130) by applying appropriate vehicle commands such as steering, throttle, braking and the like motions to physical control mechanisms such as steering, accelerator, brakes, and the like that guide the vehicle along the geometric path. The vehicle controller 5020 may include a processor(s) such as a microprocessor or other control circuitry such as analog circuitry, digital circuitry, or both, including an application specific integrated circuit (ASIC) for processing data. The vehicle controller 5020 may include a memory, including non-volatile memory, such as electrically erasable programmable read-only memory (EEPROM) for storing one or more routines, thresholds, captured data, or a combination thereof.

The host vehicle 5010 may operate in automated mode where a human operator is not needed to operate the vehicle 5010. In the automated mode, the vehicle control system 5000 (using for example the vehicle controller 5020, the decision unit 5130, navigation device 5090, the object detector 5200 and the other described sensors and devices) autonomously controls the vehicle 5010. Alternatively, the host vehicle may operate in manual mode where the degree or level of automation may be little more than providing steering advice to a human operator. For example, in manual mode, the vehicle system architecture 5000 may assist the human operator as needed to arrive at a selected destination, avoid interference or collision with another entity, or both, where another entity may be another vehicle, a pedestrian, a building, a tree, an animal, or any other object that the vehicle 5010 may encounter.

The navigation systems described herein are configured to determine a travel path for the host vehicle. Methods and systems for motion planning are described herein. Motion planning may be performed using a variety of methods. For example, motion planning may include one or more numerical optimization approaches such as model predictive control-based approaches. Motion planning may include sampling-base approaches such as lattice and rapidly-exploring random tree (RRT). Motion planning may include path velocity decomposition approaches.

In the embodiments disclosed herein, a motion graph may include vertices and edges. Each vertex may contain the motion state along with necessary information such as a timestamp, traveled distance, car status, or the like and an edge is the connection between two vertices. A motion graph may be rooted at an initial motion state and expanded by adding vertices and edges into a graph. A vertex is added to the graph if it has an edge connected to any vertex in the graph. A motion state (x, y, θ, v, a, δ) may include a configuration space (x, y, θ, v), where position is x and y, orientation is θ, and velocity is v, and a control space (a, δ), where acceleration is a, and steering command is steer. An open vertex may be a vertex that was not previously selected to expand. A control set may be a predefined set of control inputs, which may be used to apply to a motion state to obtain a new motion state. In an implementation, a valid motion may include, and not limited to the following conditions: motion with no collision, motion result in a new motion state that may satisfy state constraints. In an implementation, a valid motion state may include, and not limited to the following conditions: a motion state that is not in a collision, a motion state that satisfies all motion state constraints, or both. The term dt may be a time interval, where during dt, a control input may be applied to a motion state to obtain a new motion state. dt may be a small time interval, for example 100 ms. One or more terminate conditions may be utilized, for example, process time>time limit, number of vertex in graph>a maximum number, coverage area>max area, or any combination thereof. The motion graph is used to search for motion trajectory(ies).

A configuration graph may include vertices and edges. Each vertex may contain a configuration state along with necessary information such as a timestamp, traveled distance, car status, or the like. In an implementation, a configuration includes position (x,y) and orientation (θ) related to or associated with a vehicle. An edge is the connection between two vertices. A configuration graph may be rooted at an initial configuration state and expanded by adding vertices and edges into graph. A configuration state (x, y, θ) may include configuration space (x, y, θ) where position is x and y and orientation is theta. An open vertex may be a vertex that was not previously selected to expand. In an implementation, a valid configuration may include and not limited to the following conditions: a configuration state with no collision, a configuration state that satisfies configuration constraints, or both. For example, configuration constraints may be xₘᵢₙ<x<xₘₐₓ; yₘᵢₙ<y<yₘₐₓ; θₘᵢₙ<θ<θₘₐₓ and the like. In an implementation, a valid connection may include, and not limited to the following conditions: connection with no collisions. A configuration graph is used to search for a path. A velocity planner is used to generate a trajectory from the path.

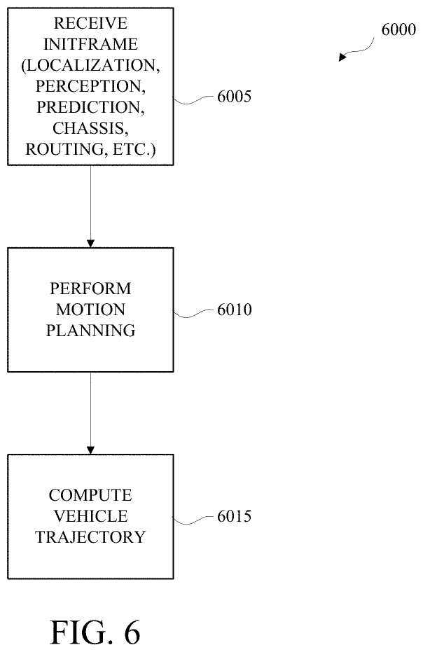

FIG. 6 is a diagram of an example of an autonomous vehicle motion planning method or technique 6000 in accordance with embodiments of this disclosure. The technique 6000 includes: receiving 6005 an initialization frame; performing 6010 motion planning using the initialization frame; and computing 6015 a vehicle trajectory. In an implementation, the technique 6000 may be performed by the decision unit 5130, the motion planner 5320, the processing unit 3010, computer 1020 and the like.

The method 6000 includes receiving 6005 an initialization frame, where the initialization frame may include information associated with localization, vehicle status (position, velocity, acceleration, chassis), map, routing, perception, prediction, behavior decision or any combination thereof.

The method 6000 includes performing 6010 motion planning based on the information in the initialization frame.

The method 6000 includes computing 6015 a vehicle trajectory based on localization, vehicle status (position, velocity, acceleration, chassis), map, routing, perception, prediction, behavior decision or any combination thereof.

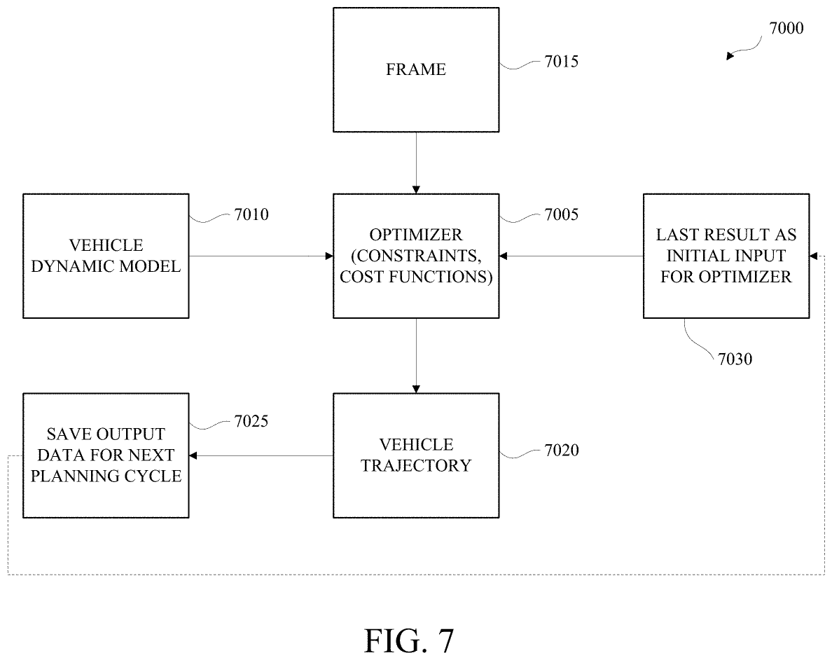

FIG. 7 is a diagram of an example of a numerical optimization method and system 7000 in accordance with embodiments of this disclosure. In an implementation, the system 7000 may include an optimizer 7005. The optimizer 7005 is configured to determine constraints and cost functions based on a received vehicle dynamic model 7010 and each received frame 7015. The optimizer 7005 may be configured to determine a vehicle trajectory 7020 based on the constraints, cost functions, or both. The vehicle trajectory 7020 and related information may be stored as output data 7025 for the next planning cycle in a memory, for example memory units 3040, 3050 shown in FIG. 3. In an implementation, the last result 7030 of the output data 7025 may be used as the initial input for the optimizer 7005. In an implementation, the method and system 7000 may be performed and implemented by the decision unit 5130, the motion planner 5320, the processing unit 3010, computer 1020 and the like.

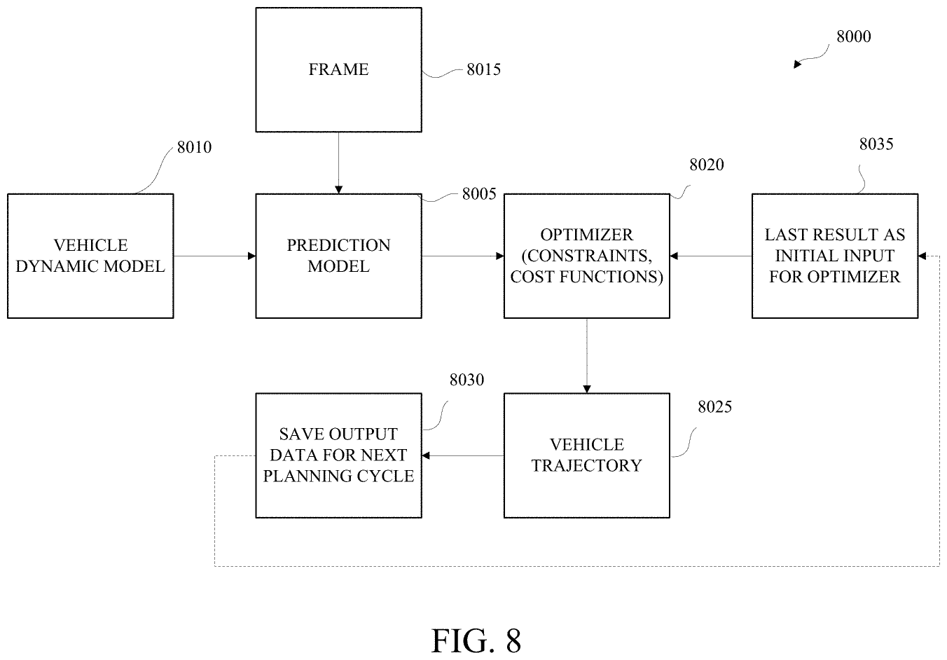

FIG. 8 is a diagram of an example of a model predictive control-based method and system 8000 in accordance with embodiments of this disclosure. A prediction model 8005 may be determined based on a vehicle dynamic model 8010 and an initial input frame 8015. The system 8000 may include an optimizer 8020. The optimizer 8020 may determine constraints and cost functions based on the prediction model 8005. The optimizer 8020 may determine a vehicle trajectory 8025 based on the constraints, cost functions, or both. The vehicle trajectory 7020 and related information may be stored as output data 8030 for the next planning cycle in a memory, for example memory units 3040, 3050 shown in FIG. 3. In an implementation, the last result 8035 of the output data 8030 may be used as the initial input for the optimizer 8030. In an implementation, the method and system 8000 may be performed and implemented by the decision unit 5130, the motion planner 5320, the processing unit 3010, computer 1020 and the like.

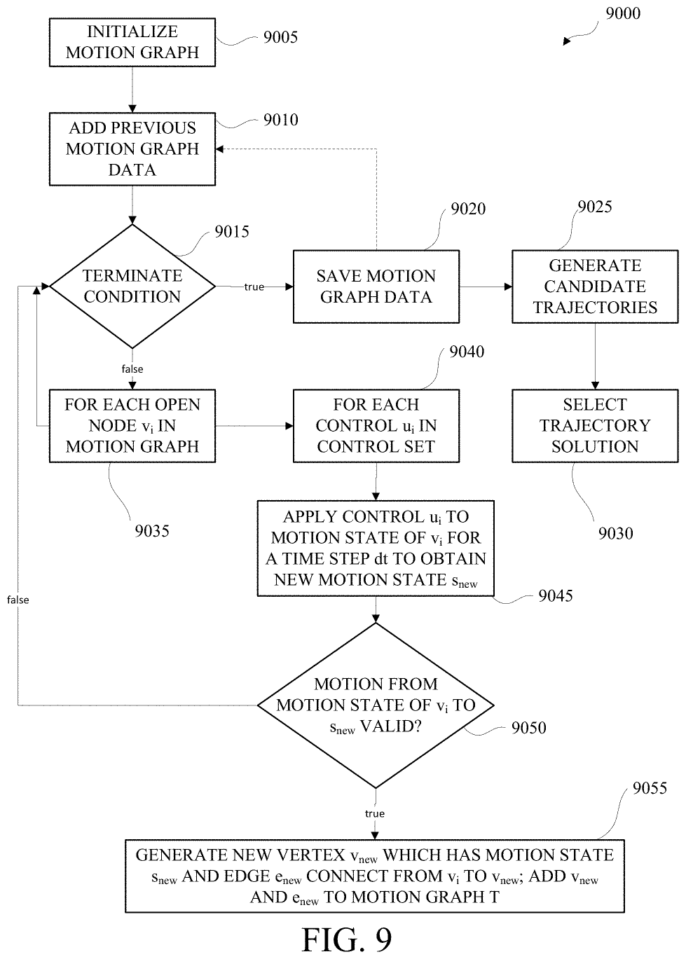

FIG. 9 is a diagram of an example of a lattice planner in a sampling-based method 9000 in accordance with embodiments of this disclosure. The method 9000 includes: initializing 9005 a motion graph; adding 9010 previous motion graph data; checking 9015 a terminate condition; if a terminate condition is true, saving 9020 motion graph data; generating 9025 candidate trajectories; selecting 9030 a trajectory solution; if a terminate condition is false, for each open node in motion graph 9035, for each control input in control set 9040, applying 9045 the control input to the motion state; determining 9050 validity of motion state; if motion state is valid, generating 9055 new vertex and new edge and add new vertex and new edge to motion graph; and if motion state is invalid, return to checking 9015 the terminate condition. In an implementation, the method 9000 may be performed and implemented by the decision unit 5130, the motion planner 5320, the processing unit 3010, computer 1020 and the like.

The method 9000 includes initializing 9005 a motion graph. In an implementation, a motion graph T may be initialized with a root vertex vᵢₙᵢₜ at an initial motion state sᵢₙᵢₜ.

The method 9000 includes adding 9010 previous motion graph data. In an embodiment, the saved motion graph data may be added to the motion graph T at initialization.

The method 9000 includes checking 9015 a terminate condition. In an implementation, a terminate condition may include a scenario where process time is greater than a predetermined time limit.

The method 9000 includes if a terminate condition is true, saving 9020 motion graph data. In an implementation, when the terminate condition is true, the motion graph data may be saved for the next planning cycle. For example, from the initial state, each vertex in the previous motion planning graph may be connected to the motion graph T, and any infeasible motion may be discarded.

The method 9000 includes generating 9025 candidate trajectories. In an implementation, the saved motion graph may be used to generate one or more candidate trajectories. A motion-planning goal may be specified by mission and behavior planning as shown in FIG. 5. A set of vertices in the motion graph that satisfy the motion-planning goal may be selected as goal motions. A set of trajectories may be generated by concatenating the motions associated with the edge that connect the root motion to the goal motions.

The method 9000 includes selecting 9030 a trajectory solution. The selecting 9030 a trajectory solution may include selecting a trajectory with the best trajectory cost as the solution trajectory. A trajectory cost may include, and is not limited to, distance travel, smoothness, comfort, safety, or any combination thereof.

The method 9000 includes, if a terminate condition is false, for each open node in motion graph 9035, for each control input in control set 9040, applying 9045 the control input to the motion state. A control input may be applied to a motion state over a time interval dt to obtain a new motion state. In an implementation, if the terminate condition is false, for each open vertex vᵢ in the motion graph, and for each control uᵢ in a control set, a control uᵢ may be applied to the motion state of vᵢ for a time step dt to obtain a new motion state s_{new}. In an implementation, a look-up (LUT) table may be used when applying the control input to obtain a new motion state to decrease calculation time. In an implementation, for an initial state (e.g. vehicle motion state) s=(x, y, θ, v, δ)ᵢₙᵢₜ and an input control u=(a, \dot{δ}) applied for a time interval dt, updated states (x, y, θ, v, δ)_{updated} may be calculated and stored in the LUT, where x and y are positions, θ is orientation heading, v is velocity, a is acceleration, δ is steering angle, and δ is steering rate. In an implementation, access to the LUT may use vehicle motion state and input control. In an implementation, access to the LUT may use a combination of vehicle motion state and input control parameters. In an implementation, the LUT may be pre-calculated and stored at motion planning execution. In an implementation, the LUT may be populated when a velocity planner is executed. In an implementation, the LUT may be populated for use in velocity or motion update processing.

The method 9000 includes determining 9050 validity of motion state. In an implementation, the determining 9050 determines whether the motion from a motion state of vᵢ to s_{new} is valid.

The method 9000 includes, if motion state valid, generating 9055 new vertex and new edge. In an implementation, if the motion is valid, the generating 9055 may include generating a new vertex v_{new} which has a motion state s_{new}, and an edge e_{new} which indicates the connection from vᵢ to v_{new}, and then adding v_{new} and e_{new} to the motion graph T.

The method 9000 includes, if motion state invalid, return to checking 9015 the terminate condition. If the motion planning component determines that the motion is not valid, it may proceed to determine whether a terminate condition applies.

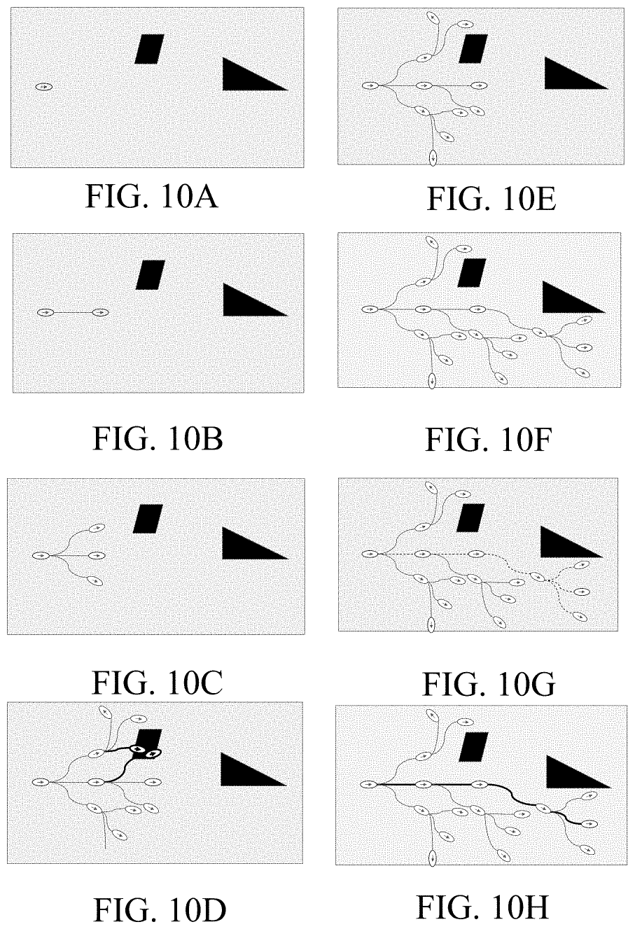

FIGS. 10A-10M are diagrams of an example lattice planner graphical sequence in accordance with embodiments of this disclosure. FIG. 10A shows a motion graph initialized with a single vertex (shown as an oval), where a vertex contains a motion state (x, y, θ, v, a, δ) at initial vehicle state along with other information like timestamp, vehicle status and the like. The vertex has an initial motion state (x1, y1, θ1, v1, a1, δ1) and a timestamp and traveled distance set to zero.

FIGS. 10B-10C show that for each open node (a node which was never selected before), each control input in the control set (3 controls shown in this example) is applied to generate a new motion state, (i.e. a motion state (x2, y2, θ2, v2, a2, δ2) with a timestamp set to 0.1 and traveled distance set to 1). If the motion to new motion state (black line) is valid (no collision), add new motion state to motion graph as a new vertex (oval) and new edge (black line).

FIG. 10D-10E show repeating the process of selecting open nodes and applying the control inputs. If the motion to new motion state (heavy line) is invalid (collision), do not add new motion states to the motion tree.

FIG. 10F shows repeating the process until a terminal condition is met.

FIG. 10G shows selecting the candidate trajectory (dashed line) after the terminal condition is meet.

FIG. 10H shows selecting the solution trajectory (dark line).

FIG. 10I shows a next planning cycle with new obstacle(s), where the motion graph is initialized with a new initial motion state (current vehicle state).

FIGS. 10J-10K show adding the previous planning data to new motion graph and discarding all invalid motion.

FIG. 10L shows repeating the process to extend motion graph and get candidate trajectory (dashed line).

FIG. 10M shows selection of the solution trajectory.

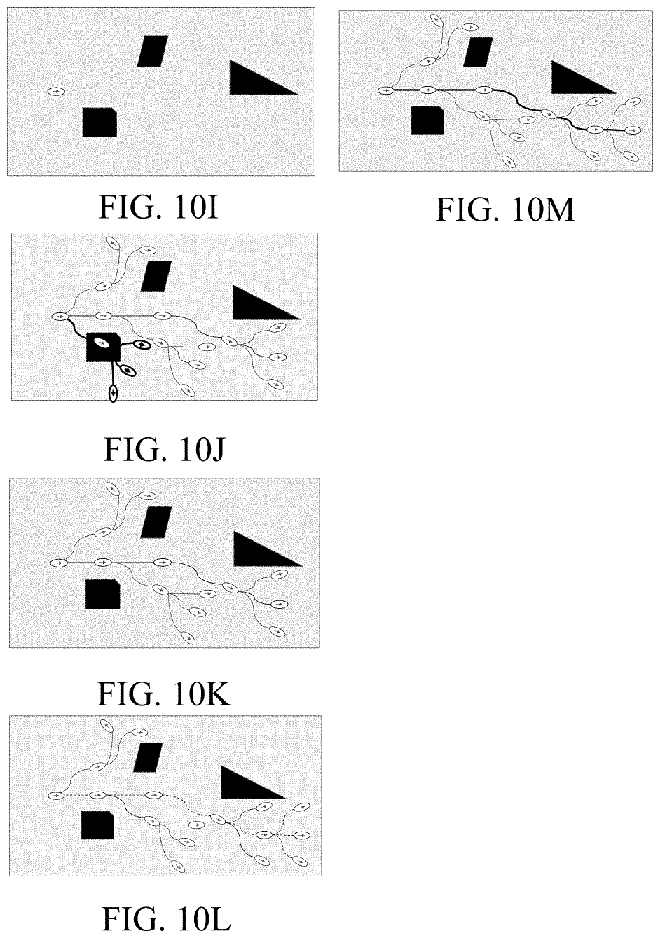

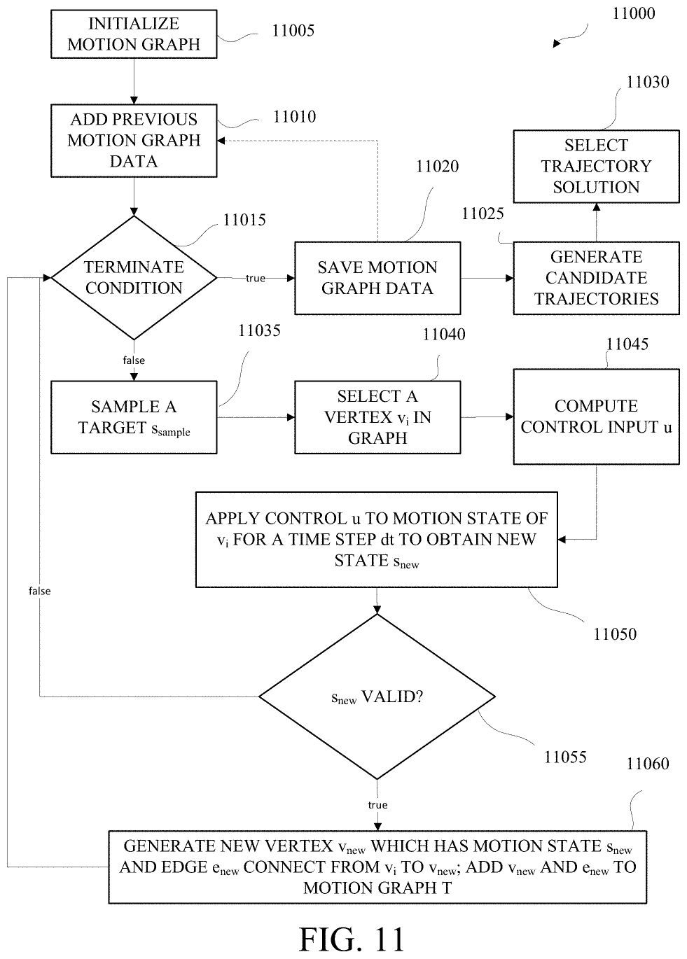

FIG. 11 is a diagram of an example of a rapidly-exploring random tree (RRT) and its variants (RRT-type) in a sampling-based method 11000 in accordance with embodiments of this disclosure. The method 11000 includes: initializing 11005 a motion graph; adding 11010 previous motion graph data; checking 11015 a terminate condition; if a terminate condition is true, saving 11020 motion graph data; generating 11025 candidate trajectories; selecting 11030 a trajectory solution; if a terminate condition is false, sampling 11035 a target; selecting 11040 a vertex in motion graph; computing 11045 a control input; applying 11050 the control input to the vertex's motion state to generate a new motion state; determining 11055 validity of the new motion state; if the new motion state is valid, generating 11060 new vertex and new edge and add new vertex and new edge to motion graph and returning to checking 11015 for terminate condition; and if the new motion state is invalid, return to checking 11015 for terminate condition. In an implementation, the method 11000 may be performed and implemented by the decision unit 5130, the motion planner 5320, the processing unit 3010, computer 1020 and the like.

The method 11000 includes initializing 11005 a motion graph. In an implementation, a motion graph T may be initialized with a root vertex vᵢₙᵢₜ at initial motion state sᵢₙᵢₜ.

The method 11000 includes adding 11010 previous motion graph data. In an embodiment, the saved motion graph data may be added to the motion graph T at initialization.

The method 11000 includes checking 11015 for a terminate condition. In an implementation, a terminate condition may include a scenario where process time is greater than a predetermined time limit.

The method 11000 includes if a terminate condition is true, saving 11020 motion graph data. In an implementation, the motion graph data may be saved for the next planning cycle. For example, from the initial state, each vertex in the previous motion planning graph may be connected to the motion graph T, and any infeasible motion may be discarded.

The method 11000 includes generating 11025 candidate trajectories. In an implementation, the saved motion graph may be used to generate one or more candidate trajectories. A motion-planning goal may be specified by a mission and behavior planning as shown in FIG. 5. A set of vertices in the motion graph T that satisfy the motion-planning goal may be selected as goal motions.

The method 11000 includes selecting 11030 a trajectory solution. In an implementation, a set of trajectories may be generated by concatenating the motions associated with the edge that connect the root motion to the goal motions. In an implementation, the selecting 11030 a trajectory solution may include selecting a trajectory with the best trajectory cost as the solution trajectory. A trajectory cost may include, and is not limited to, distance travel, smoothness, comfort, safety, or any combination thereof.

The method 11000 includes, if a terminate condition is false, sampling 11035 a target. In an implementation, if the terminate condition is false, a target sₛₐₘₚₗₑ may be sampled; the sₛₐₘₚₗₑ must satisfy the configuration constrains. For example, a configuration target may be sampled with (x, y, θ) with x,y, θ satisfy the configuration constrains (xₘᵢₙ<x<xₘₐₓ; yₘᵢₙ<y<yₘₐₓ; θₘᵢₙ<θ<θₘₐₓ).

The method 11000 includes selecting 11040 a vertex. In an implementation, a vertex vᵢ may be selected in the motion graph.

The method 11000 includes computing 11045 a control input. In an implementation, a control input u is computed to generate a motion from the selected vertex's motion state to sₛₐₘₚₗₑ.

The method 11000 includes applying 11050 the control input to the motion state. A control input may be applied to a motion state over a time interval dt to obtain a new motion state. In an implementation, a control u may be applied to vᵢ's motion state for a time step dt to obtain a new motion state s_{new}. In an example, a LUT may be used when applying the control input to obtain a new motion state to decrease the calculation time. In an implementation, a look-up (LUT) table may be used when applying the control input to obtain a new motion state to decrease calculation time. In an implementation, for an initial state (e.g. vehicle motion state) s=(x, y, θ, v, δ)ᵢₙᵢₜ and an input control u=(a, \dot{δ}) applied for a time interval dt, updated states (e.g. updated vehicle motion states) (x, y, θ, v, δ)_{updated} may be calculated and stored in the LUT, where x and y are positions, θ is orientation heading, v is velocity, a is acceleration, δ is steering angle, and δ is steering rate. In an implementation, access to the LUT may use vehicle motion state and input control. In an implementation, access to the LUT may use a combination of vehicle motion state and input control parameters. In an implementation, the LUT may be pre-calculated and stored at motion planning execution. In an implementation, the LUT may be populated when a velocity planner is executed. In an implementation, the LUT may be populated for use in velocity or motion update processing.

The method 11000 includes determining 11055 validity of motion state. In an implementation, determining 11055 may determine whether new motion state s_{new} is valid.

The method 11000 includes, if motion state is valid, generating 11060 a new vertex and new edge and returning to checking 11015 for terminate condition. In an implementation, if s_{new} is valid, the generating 11060 may generate a new vertex v_{new}, which has a motion state s_{new} and edge e_{new}, which indicates the connection from vᵢ to v_{new} and then adding v_{new} and e_{new} to the motion graph T.

The method 11000 includes, if motion state invalid, return to checking 11015 for terminate condition.

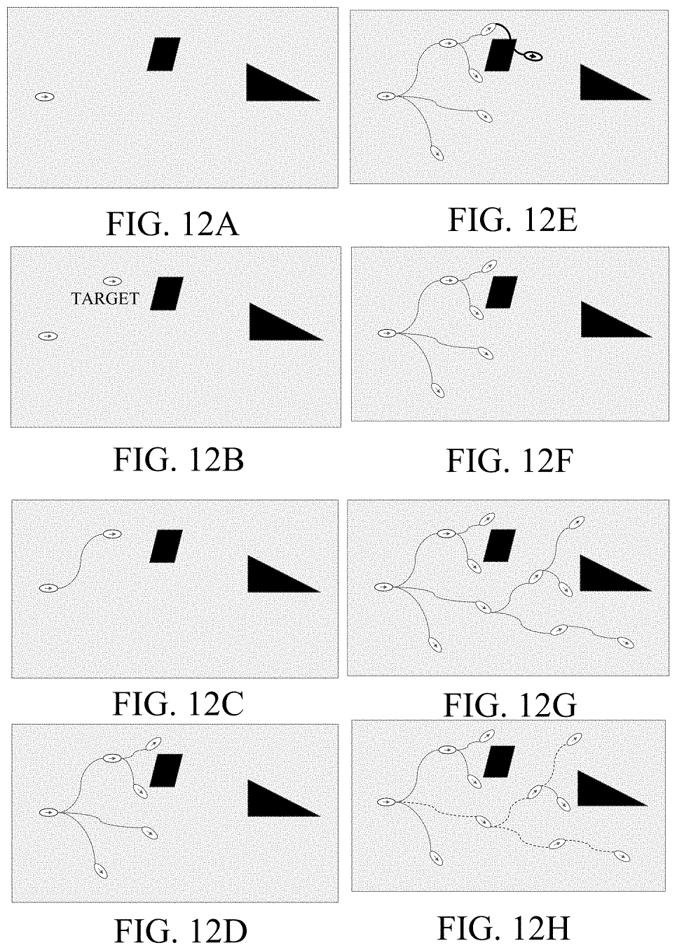

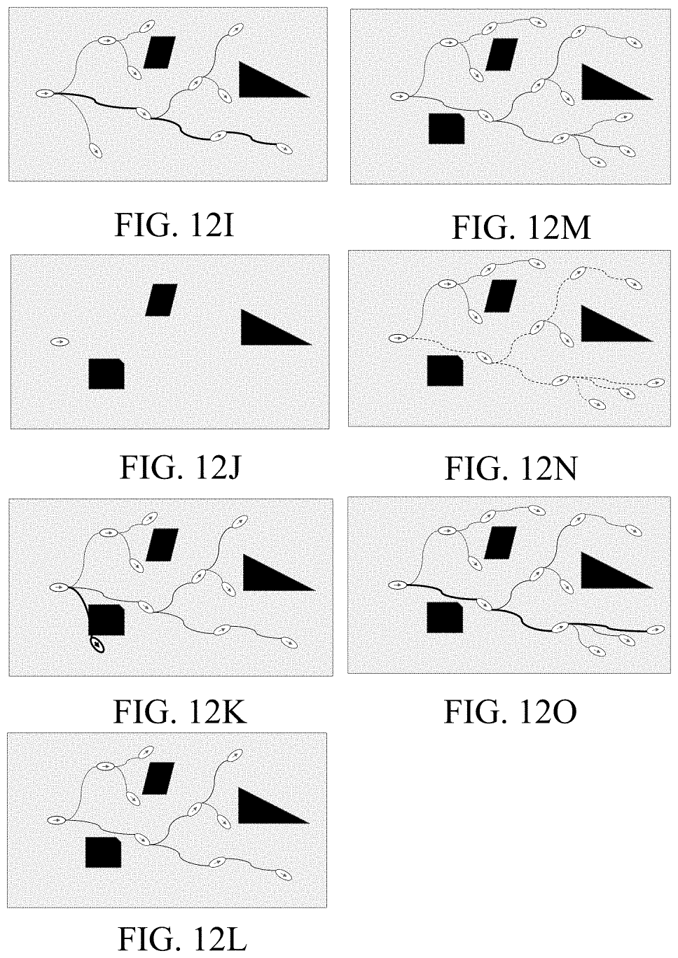

FIGS. 12A-12O are diagrams of an example a sampling-based planner graphical sequence in accordance with embodiments of this disclosure. FIG. 12A shows a motion graph initialized with a single vertex (shown as an oval), where a vertex contains motion state (x, y, θ, v, a, δ) along with other information like timestamp, vehicle status and the like. The vertex has an initial motion state (xᵢₙᵢₜ, yᵢₙᵢₜ, θᵢₙᵢₜ, vᵢₙᵢₜ, δᵢₙᵢₜ,

FIG. 12B shows a sampled target at (xₛₐₘₚₗₑ, yₛₐₘₚₗₑ, ° sample) and selection of a vertex in the motion graph to extend from.

FIG. 12C shows computation of a control u to generate a motion from selected vertex's motion state to sampled target. If the motion to new motion state (black line) is valid (no collision), then add new motion state (with x₂, y₂, θ₂, v₂, a₂, δ₂) to the motion graph as a new vertex (oval) and a new edge (black line).

FIG. 12D shows repeating the process of sampling targets and selecting vertices in the motion graph, generate motion from selected vertex′motion state to sampled target.

FIGS. 12E-12F show not adding the motion to sampled target if the motion is invalid.

FIG. 12G shows repeating the process until a terminal condition is met.

FIG. 12H shows selecting candidate trajectories (dashed lines) when a terminal condition is met.

FIG. 12I shows selecting a solution trajectory (heavy dark line) from the candidate trajectories.

FIG. 12J shows a next planning cycle with new obstacle(s), where the motion graph is initialized with a new initial motion state (current vehicle state).

FIGS. 12K-12L show adding the previous planning data to new motion graph and discarding all invalid motion.

FIG. 12M-12N show repeating the process of sampling random targets, selecting vertices to extend motion graph and selecting candidate trajectories (dashed line).

FIG. 12O shows selection of the solution trajectory.

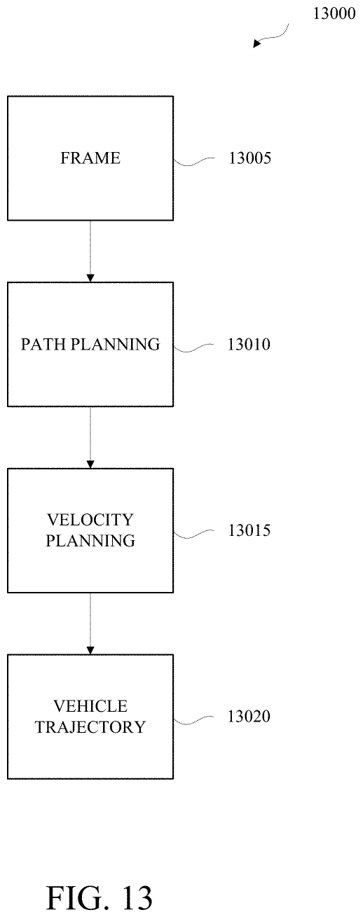

FIG. 13 is a diagram of an example of a path velocity decomposition method 13000 in accordance with embodiments of this disclosure. The method 13000 includes: receiving 13005 a frame; performing 13010 path planning using information from the planning frame; performing 13015 velocity planning on a path; and determining 13020 a vehicle trajectory based on the path and velocity. In an implementation, the method 13000 may be performed and implemented by the decision unit 5130, the motion planner 5320, the processing unit 3010, computer 1020 and the like.

The method 13000 includes receiving 13005 a frame. In an implementation, the frame may be a motion planning frame.

The method 13000 includes performing 13010 path planning using information from the frame. In an implementation, the performing 13010 may perform path planning on a motion planning frame to generate a collision-free path.

The method 13000 includes performing 13015 velocity planning on a path. In an implementation, the performing 13015 may perform velocity planning (i.e., speed planning) to generate an optimal velocity profile along the path generated from path planning. In an implementation, the performing 13015 may account for account user references, traffic rules, maneuver requirements, or any combination thereof.

The method 13000 includes determining 13020 a vehicle trajectory. In an implementation, the determining 13020 may be based on the path planning and velocity planning.

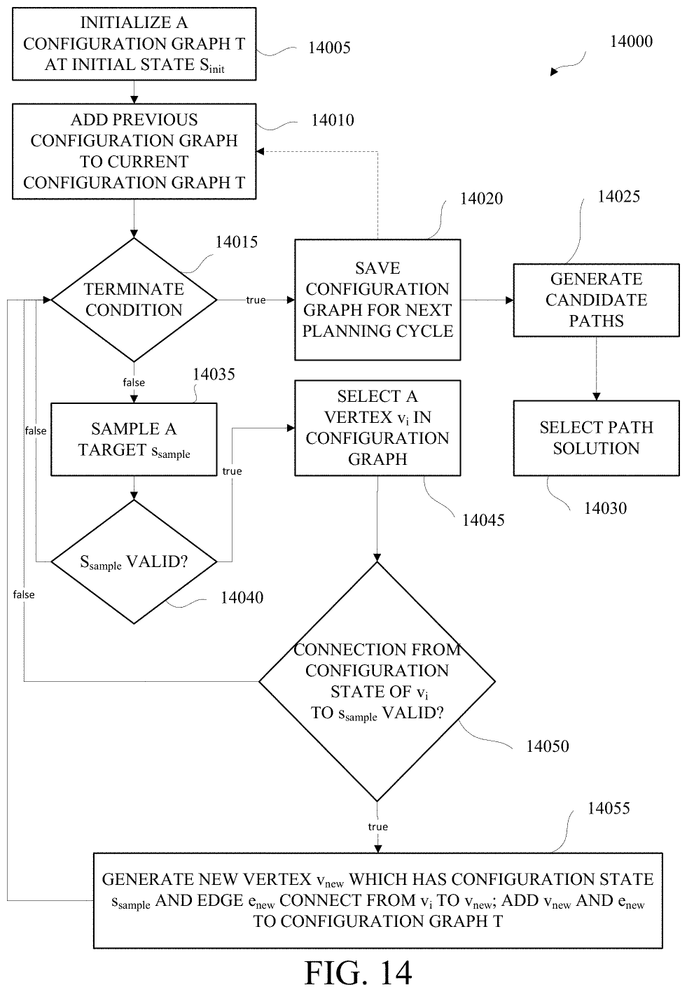

FIG. 14 is a diagram of an example of an RRT path planner in a path velocity decomposition method 14000 in accordance with embodiments of this disclosure. The method 14000 includes: initializing 14005 a configuration graph; adding 14010 previous configuration graphs to current configuration graph; checking 14015 a terminate condition; if a terminate condition is true, saving 14020 configuration graph data; generating 14025 candidate paths; selecting 14030 a path solution; if a terminate condition is false, sampling 14035 a target; determining 14040 validity of target configuration state; if a configuration state is valid, selecting 14045 a vertex; checking 14050 if a connection is valid; if a connection is valid, generating 14055 a new vertex and new edge and returning to checking 14015 for a terminate condition; if a configuration state is invalid, returning to checking 14015 for a terminate condition; if a connection is invalid, returning to checking 14015 for a terminate condition. In an implementation, the method 14000 may be performed and implemented by the decision unit 5130, the motion planner 5320, the processing unit 3010, computer 1020 and the like.

The method 14000 includes initializing 14005 a configuration graph. In an implementation, a configuration graph T may be initialized with a root at initial configuration state sᵢₙᵢₜ.

The method 14000 includes adding 14010 previous configuration graphs to current configuration graph. In an embodiment, the previous configuration graph data may be added to the configuration graph T at initialization. For example, from the initial state, previous configuration graph data may be added, and any infeasible data may be discarded.

The method 14000 includes checking 14015 a terminate condition. For example, a terminate condition may include a scenario where process time is greater than a predetermined time limit.

The method 14000 includes if a terminate condition is true, saving 14020 configuration graph data. In an implementation, the configuration graph may be saved for the next planning cycle.

The method 14000 includes generating 14025 candidate paths. In an implementation, the saved configuration graph may be used to generate one or more candidate paths. A path planning goal may be specified by mission and behavior planning as shown in FIG. 5. A set of vertices in the configuration graph that satisfy the path planning goal may be selected as a goal configuration. In an implementation, a set of paths may be generated by concatenating the configuration associated with the edge that connect the root configuration to the goal configuration.

The method 14000 includes selecting 14030 a path solution. The selecting 14030 may include selecting a path with the best path cost as the solution path. A path cost may include, and is not limited to, distance travel, smoothness, comfort, safety, or any combination thereof.

The method 14000 includes, if a terminate condition is false, sampling 14035 a target. In an implementation, the sampling 14035 may include sampling a target sₛₐₘₚₗₑ.

The method 14000 includes determining 14040 validity of target configuration state. In an implementation, the determining 14040 may include determining whether a target sₛₐₘₚₗₑ is valid.

The method 14000 includes, if a target configuration state is valid, selecting 14045 a vertex. In an implementation, the selecting 14045 may include selecting a vertex vᵢ in the configuration graph if sₛₐₘₚₗₑ is valid.

The method 14000 includes checking 14050 if a connection is valid. In an implementation, the checking 14050 may include determining whether a connection from a configuration state of vᵢ to sₛₐₘₚₗₑ is valid. In an implementation, a valid connection is a connection with no collision.

The method 14000 includes, if a connection is valid, generating 14055 a new vertex and new edge and returning to checking 14015 for a terminate condition. In an implementation, the generating 14055 may include generating a new vertex v_{new} which has a configuration sₛₐₘₚₗₑ and edge e_{new} which indicates the connection from vᵢ to v_{new}, and then adding v_{new} and e_{new} to the configuration graph T if the connection is valid.

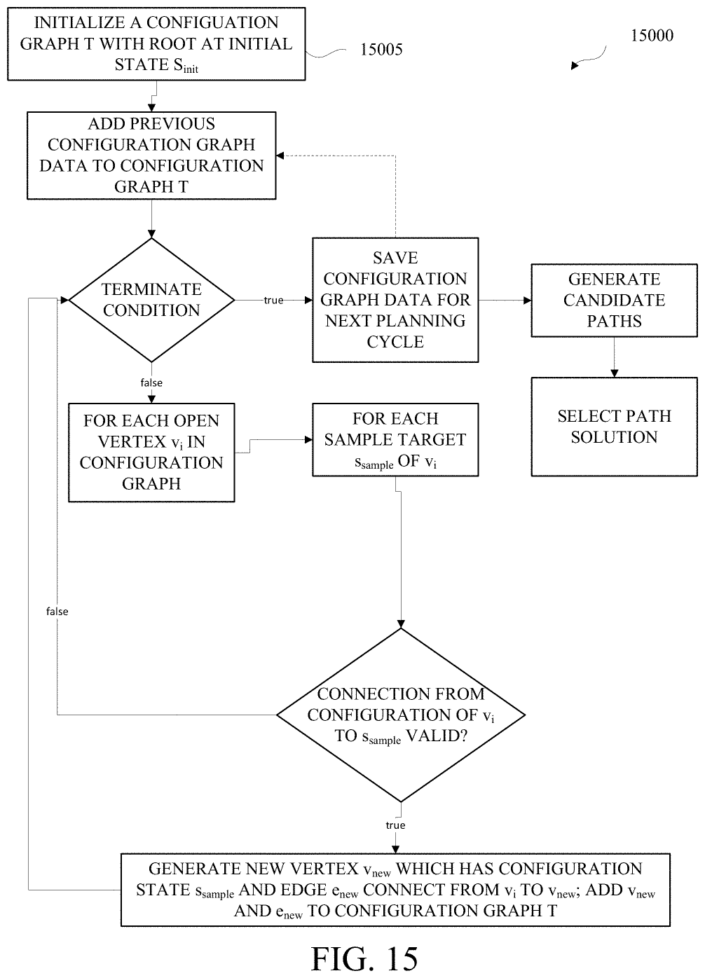

FIG. 15 is a diagram of an example of a lattice path planner in a path velocity decomposition method 15000 in accordance with embodiments of this disclosure. The method 15000 includes: initializing 15005 a configuration graph; adding 15010 previous configuration graph data; checking 15015 a terminate condition; if a terminate condition is true, saving 15020 configuration graph data; generating 15025 candidate paths; selecting 15030 a path solution; if a terminate condition is false, for each open node in configuration graph 15035, for each sample target 15040, determining 15045 if a connection is valid; if a connection is valid, generating 15050 a new vertex and a new edge, and adding the new vertex and edge to a connection graph; if a connection is invalid, returning to checking 15015 for a terminate condition. In an implementation, the method 15000 may be performed and implemented by the decision unit 5130, the motion planner 5320, the processing unit 3010, computer 1020 and the like.

The method 15000 includes initializing 15005 a configuration graph. In an implementation, a configuration graph T may be initialized with a root at initial configuration state sᵢₙᵢₜ.

The method 15000 includes adding 15010 previous configuration graph data. In an embodiment, the previous configuration graph data may be added to the configuration graph T at initialization. For example, from the initial state, previous configuration graph data may be added, and any infeasible data may be discarded.

The method 15000 includes checking 15015 a terminate condition. For example, a terminate condition may include a scenario where process time is greater than a predetermined time limit.

The method 15000 includes, if a terminate condition is true, saving 15020 configuration graph data. In an implementation, the configuration graph data may be saved for the next planning cycle.

The method 15000 includes generating 15025 candidate paths. A path planning goal may be specified by mission and behavior planning as shown in FIG. 5. A set of vertices in the configuration graph that satisfy the path planning goal may be selected as a goal configuration. In an implementation, a set of paths may be generated by concatenating the configuration associated with the edge that connect the root configuration to the goal configuration.

The method 15000 includes selecting 15030 a path solution. In an implementation, the selecting 15030 may include selecting a path with the best path cost as the solution path. A path cost may include, and is not limited to, distance travel, smoothness, comfort, safety, or any combination thereof.

The method 15000 includes, if a terminate condition is false, for each open node in configuration graph 15035, for each sample target 15040, determining 15045 if a connection is valid. In an implementation, the determining 15045 may include, for each open vertex vᵢ in the configuration graph, and for each sample target sₛₐₘₚₗₑ of vᵢ, determining whether a connection from configuration of vᵢ to sₛₐₘₚₗₑ is valid.

The method 15000 includes, if a connection is valid, generating 15050 a new vertex and a new edge, and adding the new vertex and edge to a connection graph. In an implementation, the generating 15050 may include generating a new vertex v_{new} which has a configuration state sₛₐₘₚₗₑ and edge e_{new}, which indicates the connection from vᵢ to v_{new}, and then adding v_{new} and e_{new} to the configuration graph T. If a connection is invalid, returning to checking 15015 for a terminate condition.

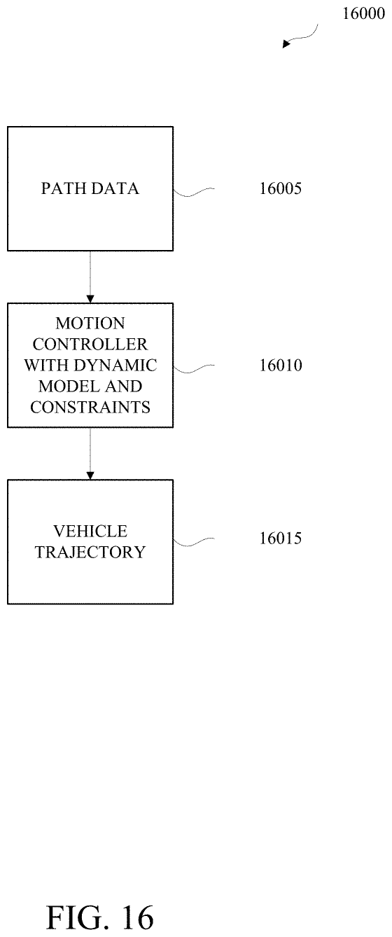

FIG. 16 is a diagram of an example of velocity planning in a path velocity decomposition method 16000 in accordance with embodiments of this disclosure. The method 16000 includes: receiving 16005 path data; applying 16010 the path data to a motion controller; and generating 16015 a vehicle trajectory. In an implementation, the method 16000 may be performed and implemented by the decision unit 5130, the motion planner 5320, the processing unit 3010, computer 1020 and the like.

The method 16000 includes receiving 16005 path data.

The method 16000 includes applying 16010 the path data to a motion controller. In an implementation, the motion controller may have a dynamic model and one or more constraints.

The method 16000 includes generating 16015 a vehicle trajectory. In an implementation, the motion controller may generate a vehicle trajectory from application of the path data to the dynamic model and one or more constraints.

A method for motion planning in an autonomous vehicle (AV). The method including: initializing a motion graph tree; executing a motion planner algorithm using at least previous motion graph data in the motion graph tree and a look-up table (LUT) to generate at least one candidate trajectory; updating the motion graph tree with motion graph data associated with the at least one candidate trajectory when a terminate condition has occurred; selecting a trajectory from the at least one candidate trajectory; and updating a controller with the trajectory to control the AV. In an implementation, the method further including on a condition that a terminate condition has not occurred, for each open node in the motion graph tree, and for each control in a control set, applying a respective control to a respective open node to obtain a new motion state. In an implementation, the method further including determining whether a motion from the open node to the new motion state is valid; adding motion graph data associated with the new motion state to the motion graph tree on a condition that the motion is valid; and discarding motion graph data on a condition that the motion is invalid motion. In an implementation, an open node is a node that was never selected for motion graph tree expansion. In an implementation, the motion graph tree includes vertices and edges, each edge being a connection between two vertices and the method further including generating the at least one candidate trajectory by concatenating motions associated with edges that connect a root motion to a goal motion. In an implementation, a motion planning goal is specified by a mission and behavior planner and a set of vertices in the motion graph tree that satisfy the motion planning goal are selected as goal motions. In an implementation, the trajectory selected is a candidate trajectory with best cost. In an implementation, the best includes at least one of distance traveled, smoothness, comfort, and safety. In an implementation, the motion graph tree includes vertices and edges, each edge being a connection between two vertices and the method further including: on a condition that a terminate condition has not occurred: sampling a target; selecting a vertex in the motion graph tree; computing a control input for a motion from the vertex to the target; obtaining a new motion state; and adding motion graph data associated with the new motion state to the motion graph tree on a condition that the new motion state is valid. In an implementation, the method further including applying the control input to a motion state of the vertex over a time step to generate the motion. In an implementation, the LUT is populated with updated motion data based on a vehicle state and input control.

A method for motion planning in an autonomous vehicle (AV). The method including: initializing a configuration graph tree; executing a path planner algorithm using at least previous configuration graph data in the configuration graph tree and to generate at least one candidate path; updating the configuration graph tree with configuration graph data associated with the at least one candidate path when a terminate condition has occurred; selecting a path from the at least one candidate path; executing a velocity planner algorithm using the selected path and a look-up table (LUT) to determine a velocity; and updating a controller with the path and the velocity to control the AV. In an implementation, the method further including: on a condition that a terminate condition has not occurred, for each open vertex in the configuration graph tree, and for each sample target in a target set: determining whether a connection from the open node to a sample target is valid; adding configuration graph data associated with the sample target to the configuration graph tree on a condition that the connection is valid; and discarding configuration graph data on a condition that the connection is invalid. In an implementation, the configuration graph tree includes vertices and edges, each edge being a connection between two vertices and the method further including generating the at least one candidate path by concatenating connections associated with edges that connect a root configuration to a goal configuration. In an implementation, a path planning goal is specified by a mission and behavior planner and a set of vertices in the configuration graph tree that satisfy the path planning goal are selected as goal configurations. In an implementation, the configuration graph tree includes vertices and edges, each edge being a connection between two vertices and the method further including: on a condition that a terminate condition has not occurred: sampling a target; selecting a vertex in the configuration graph tree; connecting the vertex to the target to generate a new configuration state; and adding configuration graph data associated with the new configuration state to the configuration graph tree on a condition that the new configuration state is valid.

An autonomous vehicle (AV) controller including a motion planner configured to: initialize a motion graph tree; execute a motion planner algorithm using at least previous motion graph data in the motion graph tree and a look-up table (LUT) to generate at least one candidate trajectory; update the motion graph tree with motion graph data associated with the at least one candidate trajectory when a terminate condition has occurred; select a trajectory from the at least one candidate trajectory; and update a controller with the trajectory to control the AV. In an implementation, the motion planner further configured to: on a condition that a terminate condition has not occurred, for each open node in the motion graph tree, and for each control in a control set, apply a respective control to a respective open node to obtain a new motion state; determine whether a motion from the open node to the new motion state is valid; add motion graph data associated with the new motion state to the motion graph tree on a condition that the motion is valid; and discard motion graph data on a condition that the motion is invalid motion. In an implementation, the motion graph tree includes vertices and edges, each edge being a connection between two vertices and the motion planner further configured to: on a condition that a terminate condition has not occurred: sample a target; select a vertex in the motion graph tree; compute a control input for a motion from the vertex to the target; obtain a new motion state; and add motion graph data associated with the new motion state to the motion graph tree on a condition that the new motion state is valid. In an implementation, the LUT is populated with updated motion data based on a vehicle state and input control.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for motion planning in an autonomous vehicle (AV), the method comprising:
initializing a motion graph tree;
executing a motion planner algorithm using at least previous motion graph data in the motion graph tree and a look-up table (LUT) to generate at least one candidate trajectory;
updating the motion graph tree with motion graph data associated with the at least one candidate trajectory when a terminate condition has occurred;
selecting a trajectory from the at least one candidate trajectory; and
updating a controller with the trajectory to control the AV.

2. The method of claim 1, further comprising:
on a condition that a terminate condition has not occurred, for each open node in the motion graph tree, and for each control in a control set, applying a respective control to a respective open node to obtain a new motion state.

3. The method of claim 2, further comprising:
determining whether a motion from the open node to the new motion state is valid;
adding motion graph data associated with the new motion state to the motion graph tree on a condition that the motion is valid; and
discarding motion graph data on a condition that the motion is invalid motion.

4. The method of claim 3, wherein an open node is a node that was never selected for motion graph tree expansion.

5. The method of claim 1, wherein the motion graph tree includes vertices and edges, each edge being a connection between two vertices and the method further comprising:
generating the at least one candidate trajectory by concatenating motions associated with edges that connect a root motion to a goal motion.

6. The method of claim 5, wherein a motion planning goal is specified by a mission and behavior planner and a set of vertices in the motion graph tree that satisfy the motion planning goal are selected as goal motions.

7. The method of claim 1, wherein the trajectory selected is a candidate trajectory with best cost.

8. The method of claim 7, wherein the best includes at least one of distance traveled, smoothness, comfort, and safety.

9. The method of claim 1, wherein the motion graph tree includes vertices and edges, each edge being a connection between two vertices and the method further comprising:
on a condition that a terminate condition has not occurred:
sampling a target;
selecting a vertex in the motion graph tree;
computing a control input for a motion from the vertex to the target;
obtaining a new motion state; and
adding motion graph data associated with the new motion state to the motion graph tree on a condition that the new motion state is valid.

10. The method of claim 9, further comprising:
applying the control input to a motion state of the vertex over a time step to generate the new motion state.

11. The method of claim 1, wherein the LUT is populated with updated motion data based on a vehicle state and input control.

12. A method for motion planning in an autonomous vehicle (AV), the method comprising:
initializing a configuration graph tree;
executing a path planner algorithm using at least previous configuration graph data in the configuration graph tree and to generate at least one candidate path;
updating the configuration graph tree with configuration graph data associated with the at least one candidate path when a terminate condition has occurred;
selecting a path from the at least one candidate path;
executing a velocity planner algorithm using the selected path and a look-up table (LUT) to determine a velocity; and
updating a controller with the path and the velocity to control the AV.

13. The method of claim 12, further comprising:
on a condition that a terminate condition has not occurred, for each open vertex in the configuration graph tree, and for each sample target in a target set:
determining whether a connection from the open node to a sample target is valid;
adding configuration graph data associated with the sample target to the configuration graph tree on a condition that the connection is valid; and
discarding configuration graph data on a condition that the connection is invalid.

14. The method of claim 12, wherein the configuration graph tree includes vertices and edges, each edge being a connection between two vertices and the method further comprising:
generating the at least one candidate path by concatenating connections associated with edges that connect a root configuration to a goal configuration.

15. The method of claim 14, wherein a path planning goal is specified by a mission and behavior planner and a set of vertices in the configuration graph tree that satisfy the path planning goal are selected as goal configurations.

16. The method of claim 12, wherein the configuration graph tree includes vertices and edges, each edge being a connection between two vertices and the method further comprising:
on a condition that a terminate condition has not occurred:
sampling a target;
selecting a vertex in the configuration graph tree;
connecting the vertex to the target to generate a new configuration state; and
adding configuration graph data associated with the new configuration state to the configuration graph tree on a condition that the new configuration state is valid.

17. An autonomous vehicle (AV) controller comprising:
a motion planner configured to
initialize a motion graph tree;
execute a motion planner algorithm using at least previous motion graph data in the motion graph tree and a look-up table (LUT) to generate at least one candidate trajectory;
update the motion graph tree with motion graph data associated with the at least one candidate trajectory when a terminate condition has occurred;
select a trajectory from the at least one candidate trajectory; and
update a controller with the trajectory to control the AV.

18. The AV controller of claim 17, the motion planner further configured to:
on a condition that a terminate condition has not occurred, for each open node in the motion graph tree, and for each control in a control set, apply a respective control to a respective open node to obtain a new motion state;
determine whether a motion from the open node to the new motion state is valid;
add motion graph data associated with the new motion state to the motion graph tree on a condition that the motion is valid; and
discard motion graph data on a condition that the motion is invalid motion.

19. The AV controller of claim 17, wherein the motion graph tree includes vertices and edges, each edge being a connection between two vertices and the motion planner further configured to:
on a condition that a terminate condition has not occurred:
sample a target;
select a vertex in the motion graph tree;
compute a control input for a motion from the vertex to the target;
obtain a new motion state; and
add motion graph data associated with the new motion state to the motion graph tree on a condition that the new motion state is valid.

20. The AV controller of claim 17, wherein the LUT is populated with updated motion data based on a vehicle state and input control.
